(19) United States
(12) Patent Application Publication
(10) Pub. No.: US 2009/0002139 A1
(43) Pub. Date: Jan. 1, 2009

(54) APPARATUS FOR SELECTIVELY PROVIDING POWER OVER ETHERNET IN AN UPGRADEABLE PATCH PANEL AND RELATED METHODS

(75) Inventor: Terry R. Cobb, Plano, TX (US)

Correspondence Address: MYERS BIGEL SIBLEY & SAJOVEC, P.O. BOX 37428, RALEIGH, NC, 27612, US

(73) Assignee: CommScope, Inc. of North Carolina

(21) Appl. No.: 11/771,125

(22) Filed: Jun. 29, 2007

(51) Int. Cl. G08B 1/00

(52) U.S. Cl. 340/333

(57) ABSTRACT

An upgradeable communications patch panel is provided. Embodiments of such a panel include multiple jacks that are configured to receive multiple communications cables and a power interface that is configured to connect to a power device and provide power to a remote communication device via one of the multiple jacks and a corresponding one of the multiple communications cables.

### FIELD OF THE INVENTION

The present invention relates generally to communication panels and, more particularly, to providing power in the context of communications panels.

### BACKGROUND

A variety of telecommunications equipment is remotely powered today. Examples of remotely powered equipment may include, for example, voice over IP telecommunications equipment, wireless Local Area Network (LAN) access points and network cameras, among others. In some systems, power is delivered to remote equipment over Ethernet segments. Such systems, commonly referred to as power-over-Ethernet (POE) may be typically provided using either of two different methods.

The first method, referred to as an end span, may provide power to remotely powered devices from the actual Ethernet switch. Reference is now made to FIG. 1, which is a block diagram illustrating an endspan system for providing POE in accordance with conventional methods. An endspan POE network switch 10 is communicatively coupled to a network patch panel 14. The endspan POE network switch 10 is configured to provide data communications and/or power via POE to remotely connected network devices that are connected directly or indirectly to the network patch panel 14. A variety of remotely powered network devices may be connected to the network patch panel 14 including, for example, an IP telephone 16, a wireless LAN access point 18, and/or a network camera 20, among others. Upgrading to a system as illustrated in FIG. 1, may require replacing existing non-POE capable switches with POE capable switches 10.

Another method, referred to as midspan, may include a POE component placed between the Ethernet switch and a network patch panel 14. For example, reference is now made to FIG. 2, which is a block diagram illustrating a midspan system for providing POE in accordance with conventional methods. A network switch 11 is communicatively coupled to a midspan POE 12. In some systems the midspan POE may replace the network patch panel 14. The midspan POE 12 includes POE functionality configured to provide power to remotely connected network devices. A variety of remotely powered network devices may be connected to the midspan POE 12 including, for example, an IP telephone 16, a wireless LAN access point 18, and/or a network camera 20, among others. Upgrading to a system as illustrated in FIG. 2, may require providing additional equipment, such as a midspan POE 12, to achieve POE functionality.

### SUMMARY

Embodiments of the present invention include upgradeable communications patch panels, racks and systems. Embodiments of such panels include multiple jacks that are configured to receive multiple communications cables that may be configured to be connected to multiple remote communication devices. Embodiments may include a front power interface, coupled to a subset of the jacks, configured to receive a selective power distributor configured to provide power to a portion of the remote communication devices corresponding to the portion of the jacks. Some embodiments include a front face of the panel configured to include multiple jacks and an opening adjacent the front power interface that provides access to the front power interface. Such embodiments may further include an internal power interface configured to receive a panel power distributor configured to power any of the remote communication devices via any of the jacks and a bus bar interface configured to receive power from a rack-mounted bus bar and provide power to the front power interface and/or the internal power interface.

Some embodiments of an upgradeable communications patch panel include multiple jacks that are configured to receive multiple communications cables and a power interface that is configured to connect to a power device and provide power to a remote communication device via one of the jacks and a corresponding one of the communications cables.

In some embodiments, the power device includes a power distributor that is configured to provide power to the remote communication device via the power interface. In some embodiments, the power interface includes a power distributor interface corresponding to a subset of the plurality of jacks and configured to receive the power distributor.

In some embodiments, the power distributor interface includes a socket that includes multiple socket electrical contacts and the power distributor includes multiple distributor electrical contacts and is configured to provide power to the remote communication device using one of the subset of the jacks. In some embodiments, the socket electrical contacts are configured to conductively engage the distributor electrical contacts.

In some embodiments, the jacks are located in a first face of the panel, the socket is located behind the first face of the panel, and the first face of the panel includes an opening that is configured to provide access to the socket for the power distributor. In some embodiments, the socket is internal to the panel and is configured to receive the power distributor via access to an interior of the panel.

In some embodiments, the power device is removable from the power interface. In some embodiments, the power interface includes multiple electrical contacts that are configured to engage multiple electrical contacts on the power device. In some embodiments, the power device includes a power distributor configured to provide power to the remote communication device and the power interface includes a power distributor interface that is connected to the jacks and that is configured to receive the power distributor.

In some embodiments, the power interface includes a power input interface that is configured to receive power for transmission to the power distributor. In such embodiments, the power input interface may include a bus bar interface that is configured to receive power from multiple bus bars mounted in a rack that is configured to receive the panel.

Some embodiments include a rack configured to receive an upgradeable communications patch panel as described herein. In some embodiments, the rack includes a chassis that is configured to support the panel and a plurality of bus bars configured to distribute power to the panel. In some embodiments, the delivered power is configured to provide power to the remote communication device via one of the plurality of jacks. Such embodiments may also include a power supply interface that is configured to receive at least one power supply.

Some embodiments of a rack include a uninterruptible power supply interface that is configured to be coupled to an uninterruptible power supply. In some embodiments, the uninterruptible power supply is mounted within the rack.

Some embodiments of the present invention include an upgradeable panel system. Embodiments of such a system may include a power distributor that is configured to provide power to a remote communication device via a network connection, a communication panel that includes a jack that is configured to receive a plug of a communication cable that is connected to the remote communication device, a power distributor interface that is configured to connect to the power distributor and that is further configured to transmit power to the remote communication device via the jack and the communication cable, a power input interface that is configured to receive electrical power for transmission to the power distributor, and a chassis configured to retain the jack, the power distributor interface and the power input interface. Such embodiments may also include an input power device that is configured to be connected to the power input interface and that is configured to provide electrical power to the power distribution device.

In some embodiments, the communication panel includes multiple jacks and the power distributor includes a selective power distributor that is configured to transmit power to the remote communication device via one of a subset of the jacks. In some embodiments, the communication panel includes multiple jacks located proximate to a front plate and an opening in the front plate that is configured to receive the power distributor corresponding to a subset of the jacks. In such embodiments, at least one of the subset of jacks may be configured to transmit power to at least one remote communication device via at least one of multiple communication cables that are connected to the at least one of the subset of the jacks.

In some embodiments, the communication panel includes multiple jacks and the power distributor includes a panel power distributor that is configured to transmit power to the remote communication device via one of the jacks.

Some embodiments may also include multiple bus bars that are configured to transmit power from the input power device to the power input interface.

In some embodiments, the input power device includes a modular power device.

In some embodiments, the panel includes an uninterruptible power supply interface that is configured to be coupled to an uninterruptible power supply.

### BRIEF DESCRIPTION OF THE DRAWINGS

FIG. 1 is a block diagram illustrating a system for providing power over Ethernet in accordance with conventional methods.

FIG. 2 is a block diagram illustrating another system for providing power over Ethernet in accordance with conventional methods.

FIG. 3 is a block diagram illustrating a system for providing power over Ethernet in accordance with some embodiments of the present invention.

FIGS. 4A and 4B are a front view and a side cross-sectional view taken along direction A of FIG. 4A, respectively, illustrating an upgradeable network patch panel in accordance with some embodiments of the present invention.

FIG. 4C is a front view of an upgradeable network patch panel as illustrated in FIGS. 4A and 4B with a power device installed in accordance with some embodiments of the present invention.

FIGS. 5A and 5B are a front view and a side cross-sectional view taken along direction A of FIG. 5A, respectively, illustrating an upgradeable network patch panel in accordance with further embodiments of the present invention.

FIGS. 6A and 6B are a front view and a side cross-sectional view taken along direction A of FIG. 6A, respectively, illustrating an upgradeable network patch panel in accordance with yet further embodiments of the present invention.

FIGS. 7A and 7B are a front view and a side cross-sectional view taken along direction A of FIG. 7A, respectively, illustrating an upgradeable network patch panel in accordance with some embodiments of the present invention.

FIG. 7C is a front view of an upgradeable network patch panel as illustrated in FIGS. 7A and 7B with a power device installed in accordance with some embodiments of the present invention.

FIG. 8 is a rear cut-away view of a network patch panel rack including bus bars according to some embodiments of the present invention.

FIG. 9 is a rear cut-away view of a network patch panel rack including bus bars and an uninterruptible power supply according to some embodiments of the present invention.

### DETAILED DESCRIPTION

The present invention will be described more particularly hereinafter with reference to the accompanying drawings. The invention is not intended to be limited to the illustrated embodiments; rather, these embodiments are intended to fully and completely disclose the invention to those skilled in this art. In the drawings, like numbers refer to like elements throughout. Thiclnesses and dimensions of some components may be exaggerated for clarity.

Spatially relative terms, such as “under”, “below”, “lower”, “lover”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

This invention is directed to communications panels, with a primary example of such being a patch panel. As used herein, the terms “forward”, “forwardly”, and “front” and derivatives thereof refer to the direction defined by a vector extending from the center of the panel toward the face of the panel that includes the plug openings for the patch panel jacks. Conversely, the terms “rearward”, “rearwardly”, and derivatives thereof refer to the direction directly opposite the forward direction; the rearward direction is defined by a vector that extends away from the face of the panel that includes the plug openings for the patch panel jacks. Where used, the terms “attached”, “connected”, “interconnected”, “contacting”, “mounted” and the like can mean either direct or indirect attachment or contact between elements, unless stated otherwise.

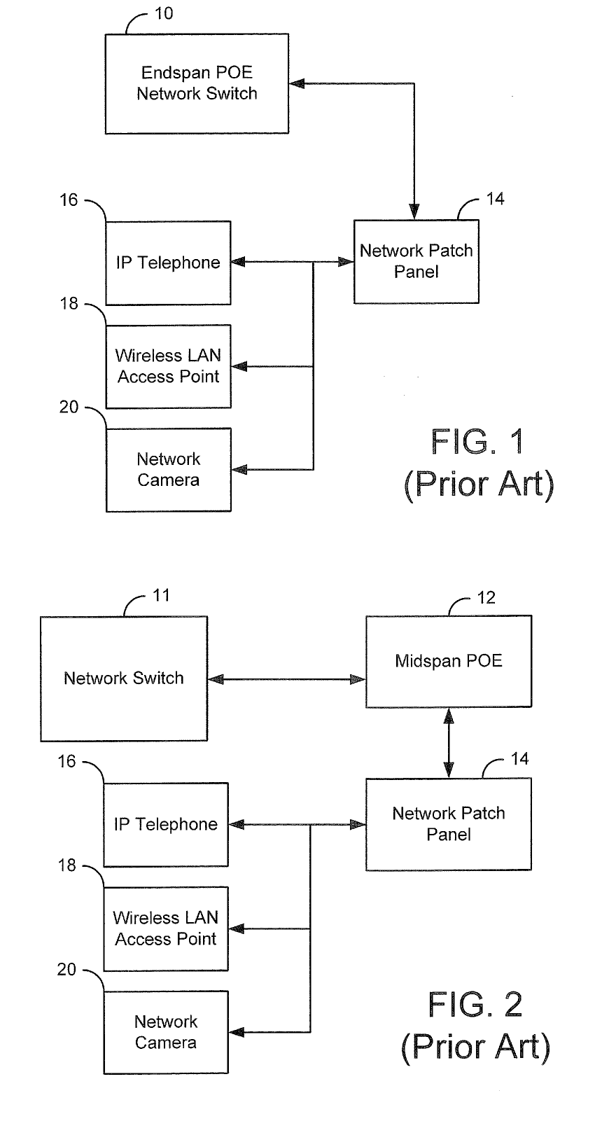

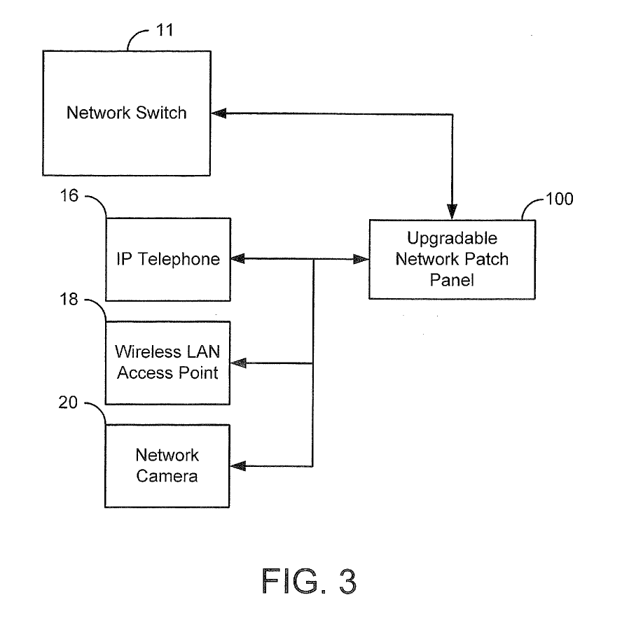

Reference is now made to FIG. 3, which is a block diagram illustrating a system for providing power over Ethernet in accordance with some embodiments of the present invention. The system includes a network switch 11 communicatively coupled to an upgradeable network patch panel 100. In some embodiments, the upgradeable network patch panel 100 may be a communications patch panel that includes functionality to provide POE with the addition of one or more additional components. The upgradeable network patch panel 100 includes, in a non-upgraded configuration, the full functionality of the network patch panel 14 as discussed above regarding FIG. 1 substantially without the additional cost associated with POE functionality. As remotely located network devices that can be powered using POE are added, the upgradeable network patch panel 100 may be configured to selectively add a POE functionality to all or a portion of the Ethernet segments connected thereto. In this manner, replacement of existing equipment and/or underutilization of POE capacity may be avoided. For example, POE functionality to support all of the Ethernet segments may be economically inefficient when only a small number of devices may utilize the POE.

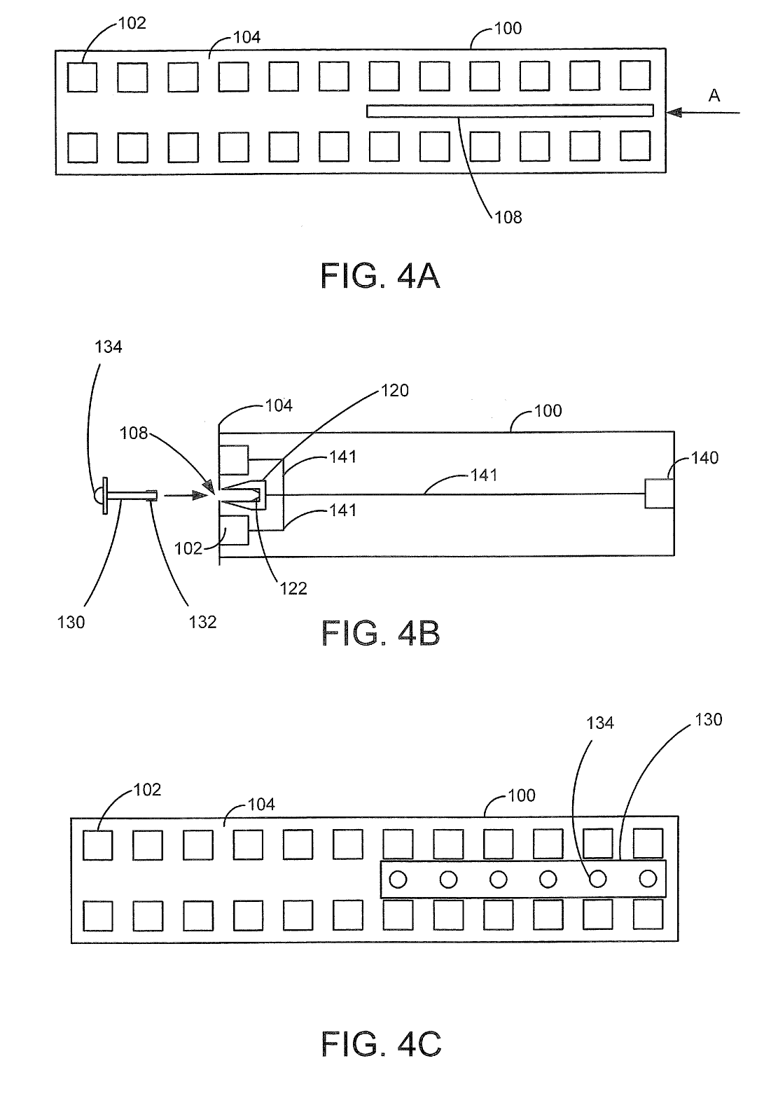

Reference is now made to FIGS. 4A and 4B, which are a front view and a side cross-sectional view taken along direction A of FIG. 4A, respectively, illustrating an upgradeable network patch panel in accordance with some embodiments of the present invention. Referring to FIG. 4A, the upgradeable network patch panel 100 includes a front faceplate 104 that includes openings for multiple communication jacks 102 configured to receive communications cables corresponding to multiple Ethernet segments. For example, each pair of upper and lower communication jacks 102 may correspond to a specific Ethernet segment where a network component connected, via a network cable, to a first jack of the pair of jacks is communicatively coupled to a network component connected, via a network cable, to a second jack of the pair of jacks. The upgradeable network patch panel 100 may include a chassis configured to support and/or retain the various components thereof. The chassis may include any of a variety of mechanical structures configured to provide mounting and/or structural support to the various panel mounted components. For example, in some embodiments, the chassis may be a frame upon which interior and/or exterior panel components are mounted to, supported by or otherwise affixed to.

In some embodiments, the front faceplate 104 includes a power device opening 108 configured to receive a power device 130 (See FIG. 4C). Although illustrated as corresponding to six of the twelve Ethernet segments, some embodiments may include one or more openings corresponding to different portions and/or all of the Ethernet segments. An Ethernet segment may include, for example, a communications channel connected via a pair of communicatively coupled communications jacks 102, such that network devices connected to the first jack of the pair of communications jacks 102 may communicate with network devices connected to the second jack of the pair of communications jacks 102. Additionally, in some embodiments, the upgradeable network patch panel 100 may be configured to support more or less than 12 Ethernet segments. Referring now to FIG. 4B, the upgradeable network patch panel 100 includes a power interface 120 that is configured to electrically engage the power device 130. The power interface 120 may be configured to provide electrical interconnection between the power device 130 and the internal components of the upgradeable network patch panel 100. For example, the power interface 120 may be conductively connected to the communications jacks 102 via internal conductors 141. In some embodiments, the internal conductors 141 may include wires and/or traces on a printed circuit board. The power interface 120 includes interface electrical contacts 122 that are configured to conductively engage power device electrical contacts 132 when the power device 130 is received by the power interface 120. In some embodiments, the power interface 120 is a socket configured to receive the power device 130 in the form of plug, card, or the like, using, for example, edge contacts/connectors.

The power device 130 is configured to provide power to remotely connected network devices that are connected to designated ones of the communications jacks 102. For example, in some embodiments, a portion of the Ethernet segments, as designated, for example, by relative location of the power device 130, correspond to communication jacks that are configured to provide POE to remotely located network devices. Some embodiments may provide one or more power device openings 108 located at positions other than corresponding to communications jacks 102. For example, a power device opening 108 may be vertically oriented and positioned in a manner that is not spatially indicative of which communications jacks 102 are affected by a power device 130 received therein. The power device 130 may be configured to receive power via the power interface 120 from a power input interface 140. A power input interface 140 may be utilized to provide an interface that couples an external power source to, for example, the power device 130, which may then distribute the power to various ones of the communications jacks 102 to provide POE to externally located network devices. In some embodiments, the power interface 120 may include the power input interface 140. The power input interface 140 may be configured to receive power from an external power supply, source, and/or input power device.

The power device 130 may include indicators 134 corresponding to each of the supported Ethernet segments and may provide indication as to whether each segment is providing and/or capable of providing POE. For example, referring now to FIG. 4C, which is a front view of an upgradeable network patch panel as illustrated in FIGS. 4A and 4B with a power device installed, each pair of a portion of the communication jacks 102 may include a corresponding indicator 134 on the power device 130. The power device 130 includes voltage and/or electrical current control and/or regulation circuits as needed to provide POE to remotely located network devices. The indicator 134 may be configured to provide varying outputs to indicate different states of POE corresponding to each of the Ethernet segments. Examples of varying outputs include, for example, colors, flashing patterns, and/or luminous intensity, among others. In some embodiments, the varying outputs may provide information regarding POE states such as ON, OFF, disconnected, overload, and/or a variety of error states.

In this manner, the upgradeable network patch panel 100 can be initially provided as a non-POE panel and easily upgraded at a later time to provide POE to remotely located network devices. Additionally, since a portion of the Ethernet segments in an upgradeable network patch panel 100 may be configured for POE, a small number of remotely located network devices can be powered without adding significant unused POE functionality to other Ethernet segments.

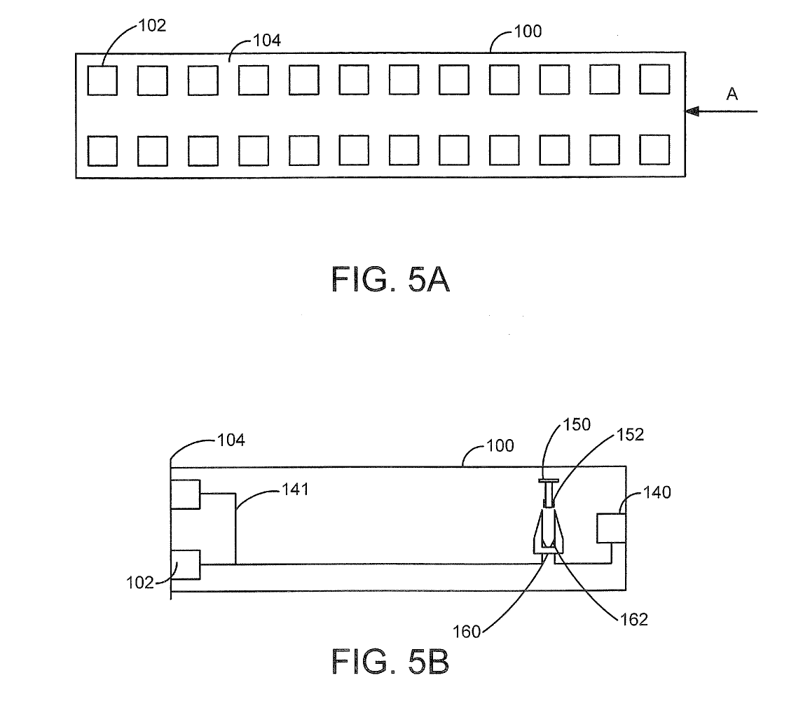

Reference is now made to FIGS. 5A and 5B, which are a front view and a side cross-sectional view taken along direction A of FIG. 5A, respectively, illustrating an upgradeable network patch panel in accordance with further embodiments of the present invention. As illustrated in FIG. 5A, an upgradeable network patch panel 100 includes a front faceplate 104 that is configured to include openings corresponding to multiple communication jacks 102 that are configured to receive communications cables cor esponding to, for example, multiple Ethernet segments. For example, each pair of upper and lower communication jacks 102 may correspond to an Ethernet segment. Referring to FIG. 5B, the upgradeable network patch panel 100 includes an internal power interface 160 configured to receive and/or conductively engage an internal power device 150.

The internal electrical power device 150 includes voltage and/or electrical current control and/or regulation circuits as needed to provide POE to remotely located network devices. The internal power interface 160 includes interface electrical contacts 162 that are configured to conductively engage internal power device electrical contacts 152 when the internal power device 150 is received by the internal power interface 160. In some embodiments, the internal power interface 160 is a socket configured to receive the internal power device 150 in the form of plug, card, or the like, using, for example, edge contacts/connectors. The internal power interface 160 may be configured to provide an electrical interface between an internal power device 150 and other components of the upgradeable network patch panel 100, such as, for example, the communications jacks 102 and/or a power input interface 140. The internal power device 150 is configured to provide power to remotely connected network devices that are connected to a portion and/or all of the communications jacks 102. For example, in some embodiments, the upgradeable network patch panel 100 may include an internal power interface 160 configured to upgrade all Ethernet segments in the upgradeable network patch panel 100 to POE capability. In some embodiments, the upgradeable network patch panel 100 may include multiple internal power interfaces 160 capable of receiving multiple internal power devices 150, with each internal power interface 160 selectively upgrading a portion of the Ethernet segments in the upgradeable network patch panel 100 to POE capability.

The internal power device 150 may be configured to receive power via the power interface 160 from a power input interface 140. In some embodiments, the power input interface 140 may be configured to receive power from an external power supply and/or source. In some embodiments, the power input interface 140 may include a bus bar interface (not shown) that is configured to engage bus bars mounted in a rack that is configured to receive the upgradeable network patch panel 100. In this manner, power may be received from, for example, a rack mounted power supply or other input power device and delivered via rack mounted bus bars. Although illustrated as distinct components, in some embodiments, the power interface 160 and the power input interface 140 may be integrated into a single component.

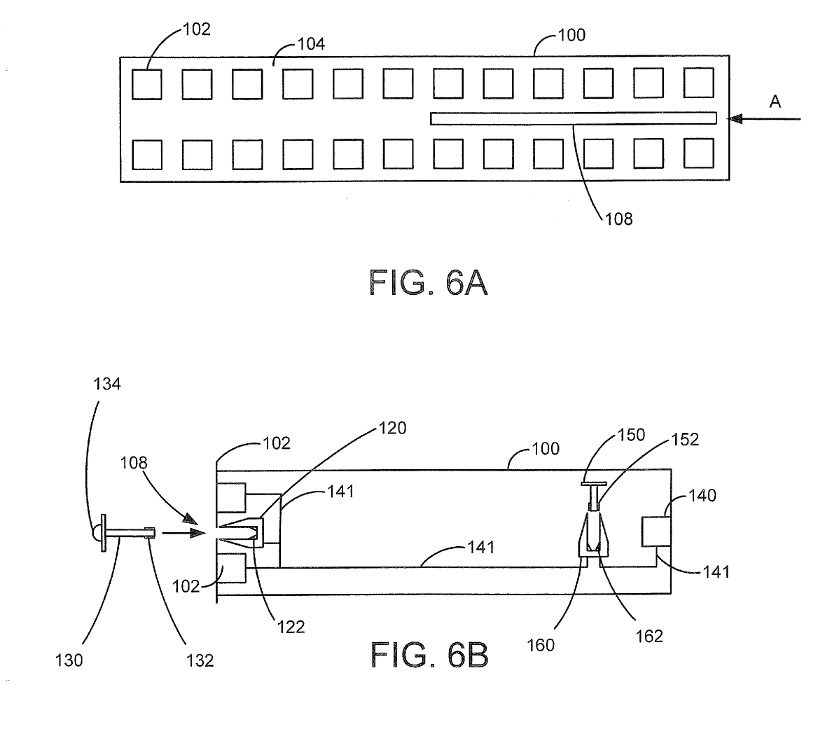

Reference is now made to FIGS. 6A and 6B, which are a front view and a side cross-sectional view taken along direction A of FIG. 6A, respectively, illustrating an upgradeable network patch panel in accordance with yet further embodiments of the present invention. Referring to FIG. 6A, the upgradeable network patch panel 100 includes multiple communication jacks 102 mounted adjacent a front faceplate 104. The communications jacks 102 are configured to receive communications cables corresponding to, for example, multiple Ethernet segments. For example, each pair of upper and lower communication jacks 102 may correspond to an Ethernet segment. In some embodiments, some of the lower communication jacks 102 of each pair may be designated as upgradeable to POE capability.

In some embodiments, the front faceplate 104 includes a power device opening 108 configured to receive a power device 130. Although illustrated as corresponding to six of the twelve Ethernet segments, some embodiments may include one or more openings corresponding to different portions and/or all of the Ethernet segments. Referring now to FIG. 6B, the upgradeable network patch panel 100 includes a power interface 120 configured to electrically engage the power device 130. The power interface 120 includes interface electrical contacts 122 configured to engage power device electrical contacts 132. Examples of types of interface electrical contacts 122 include, for example, pin, socket, pressure, and insulation displacement contacts, among others. In some embodiments, the power interface 120 is a socket configured to receive the power device 130 in the form of plug and/or card using, for example, edge contacts/connectors.

The upgradeable network patch panel 100 may include an internal power interface 160 configured to receive and/or conductively engage an internal power device 150. In some embodiments, the upgradeable network patch panel 100 may include an internal power interface 160 configured to upgrade all Ethernet segments to POE capability. In some embodiments, the upgradeable network patch panel 100 may include multiple internal power interfaces 160 capable of receiving multiple internal power devices 150 and selectively upgrading Ethernet segments to POE capability. By including a power interface 120 that is accessible through the front faceplate 104 and an internal power interface 160 that is accessible only by opening the enclosure of the upgradeable network patch panel 100, the power device 130 and internal power device 150 may be selectively utilized to support a variety of POE configurations in a variety of network environments.

The power device 130 and/or the internal power device 150 may be configured to receive power via the power interface 160 from a power input interface 140. The power input interface 140 may be configured to receive power from an external power supply and/or source. In some embodiments, the power may be received from, for example, a rack mounted power supply and delivered via rack mounted bus bars. In some embodiments, the power device 130 and/or the internal power device 150 may each be a power distributor that receives the input power via the power input interface 140 and distributes electrical power to various ones of the communications jacks 102.

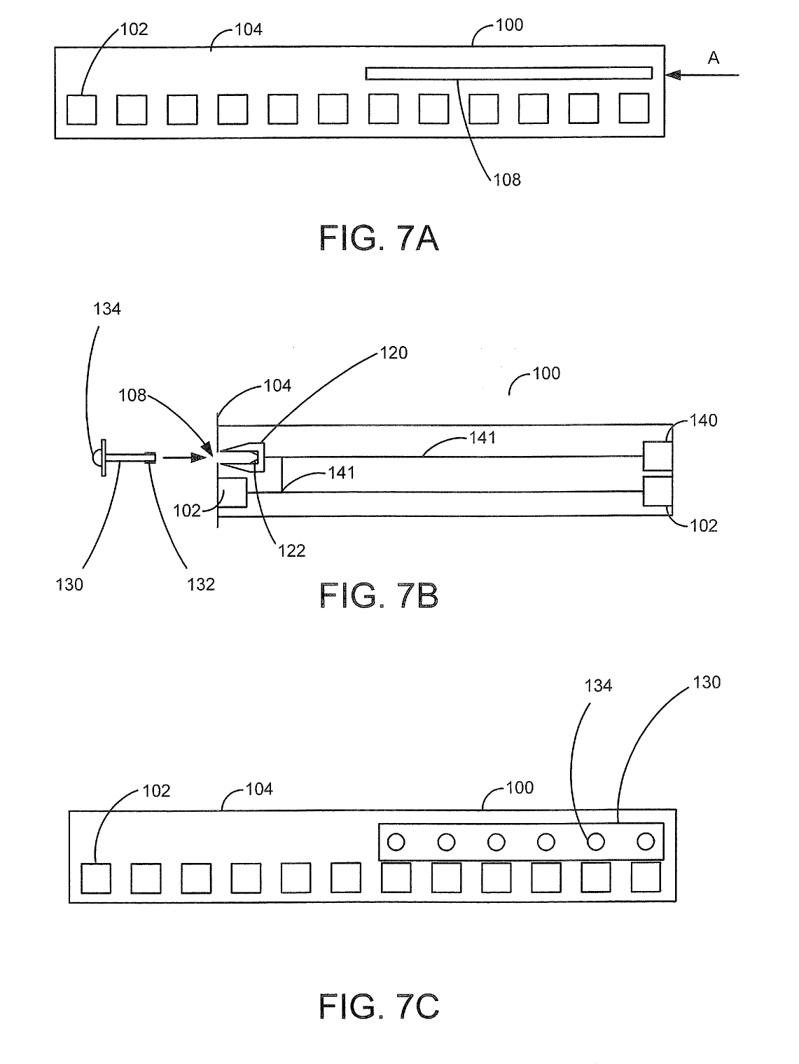

Reference is now made to FIGS. 7A and 7B, which are a front view and a side cross-sectional view taken along direction A of FIG. 7A, respectively, illustrating an upgradeable network patch panel in accordance with some embodiments of the present invention. Referring to FIG. 7A, the upgradeable network patch panel 100 includes a front faceplate 104 that includes openings for multiple communication jacks 102 configured to receive communications cables corresponding to multiple Ethernet segments. As illustrated in FIG. 7B, the upgradeable network patch panel 100 may include multiple communications jacks 102 at the rear portion of the upgradeable network patch panel 100. For example, communications jack 102 at the front faceplate 104 may include a corresponding communications jack 102 at the rear of the panel such that each pair of front and rear communication jacks 102 may correspond to a specific Ethernet segment. In this manner, a network component connected, via a network cable, to a front communications jack is communicatively coupled to a network component connected, via a network cable, to a rear communications jack. The upgradeable network patch panel 100 may include a chassis configured to support and/or retain the various components thereof. The chassis may include any of a variety of mechanical structures configured to provide mounting and/or structural support to the various panel mounted components. For example, in some embodiments, the chassis may be a frame upon which interior and/or exterior panel components are mounted to, supported by or otherwise affixed to.

In some embodiments, the front faceplate 104 includes a power device opening 108 configured to receive a power device 130 (See FIG. 7C). Although illustrated as corresponding to six of the twelve Ethernet segments, some embodiments may include one or more openings corresponding to different portions and/or all of the Ethernet segments. An Ethernet segment may include, for example, a communications channel connected via a pair of communicatively coupled communications jacks 102, such that network devices connected to the front jack of the pair of communications jacks 102 may communicate with network devices connected to the rear jack of the pair of communications jacks 102. Additionally, in some embodiments, the upgradeable network patch panel 100 may be configured to support more or less than 12 Ethernet segments. Referring now to FIG. 7B, the upgradeable network patch panel 100 includes a power interface 120 that is configured to electrically engage the power device 130. The power interface 120 may be configured to provide electrical interconnection between the power device 130 and the internal components of the upgradeable network patch panel 100. For example, the power interface 120 may be conductively connected to the communications jacks 102 via internal conductors 141. In some embodiments, the internal conductors 141 may include wires and/or traces on a printed circuit board. The power interface 120 includes interface electrical contacts 122 that are configured to conductively engage power device electrical contacts 132 when the power device 130 is received by the power interface 120. In some embodiments, the power interface 120 is a socket configured to receive the power device 130 in the form of plug, card, or the like, using, for example, edge contacts/connectors.

The power device 130 is configured to provide power to remotely connected network devices that are connected to designated ones of the communications jacks 102. For example, in some embodiments, a portion of the Ethernet segments, as designated, for example, by relative location of the power device 130, correspond to communication jacks that are configured to provide POE to remotely located network devices. Some embodiments may provide one or more power device openings 108 located at positions other than corresponding to communications jacks 102. For example, a power device opening 108 may be vertically oriented and positioned in a manner that is not spatially indicative of which communications jacks 102 are affected by a power device 130 received therein. The power device 130 may be configured to receive power via the power interface 120 from a power input interface 140. A power input interface 140 may be utilized to provide an interface that couples an external power source to, for example, the power device 130, which may then distribute the power to various ones of the communications jacks 102 to provide POE to externally located network devices. In some embodiments, the power interface 120 may include the power input interface 140. The power input interface 140 may be configured to receive power from an external power supply, source, and/or input power device.

The power device 130 may include indicators 134 corresponding to each of the supported Ethernet segments and may provide indication as to whether each segment is providing and/or capable of providing POE. For example, referring now to FIG. 7C, which is a front view of an upgradeable network patch panel as illustrated in FIGS. 7A and 7B with a power device installed, each of the front communication jacks 102 may include a corresponding indicator 134 on the power device 130. The power device 130 includes voltage and/or electrical current control and/or regulation circuits as needed to provide POE to remotely located network devices. The indicator 134 may be configured to provide varying outputs to indicate different states of POE corresponding to each of the Ethernet segments. Examples of varying outputs include, for example, colors, flashing patterns, and/or luminous intensity, among others. In some embodiments, the varying outputs may provide information regarding POE states such as ON, OFF, disconnected, overload, and/or a variety of error states.

In this manner, the upgradeable network patch panel 100 can be initially provided as a non-POE panel and easily upgraded at a later time to provide POE to remotely located network devices. Additionally, since a portion of the Ethernet segments in an upgradeable network patch panel 100 may be configured for POE, a small number of remotely located network devices can be powered without adding significant unused POE functionality to other Ethernet segments.

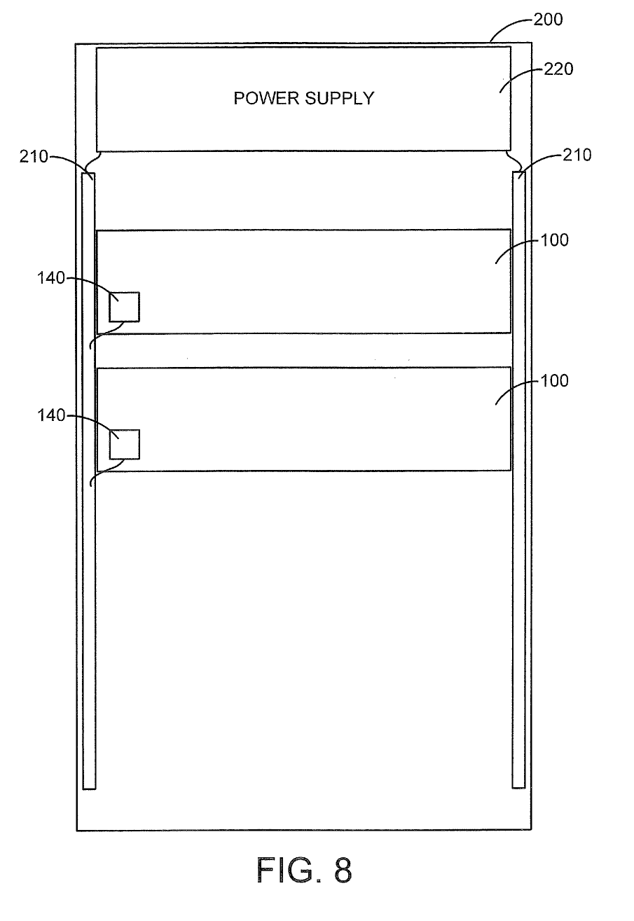

Reference is now made to FIG. 8, which is a rear cross-sectional view of a network patch panel rack including bus bars according to some embodiments of the present invention. The rack 200 may be configured to receive one or more upgradeable network patch panels 100. The rack 200 may also include a chassis configured to support the one or more upgradeable network patch panels 100. The rack 200 may also include a power supply interface that is configured to receive at least one power supply 220 and/or input power device. In some embodiments, the power supply 220 may be a modular design such that multiple devices can be used in combination to provide varying power capacities. The rack 200 includes a plurality of bus bars 210 configured to distribute power received from the power supply 220 to one or more upgradeable network patch panels 100. A bus bar 210 includes elongated conductive materials configured to provide electrical power to devices connected thereto along the length of the bus bar 210. For example, multiple bus bars 210 may be electrically energized at a variety of electrical potentials to provide one or more power circuits. The upgradeable network patch panels 100 may receive power via an electrically conductive connection between a power input interface 140 and the bus bars 210. In some embodiments, the bus bars 210 may be vertically oriented on one or both sides of the rack 200. In some embodiments, redundant bus bars 210 may be provided on both sides of the rack 200. In some embodiments, bus bars 210 at a first electrical potential may be provided on a first side of the rack 200 and bus bars 210 at a second electrical potential may be provided on a second side of the rack. In some embodiments, bus bars 210 having different electrical potentials may be provided on one side of the rack 200. In this manner, power may be delivered to a large number of POE devices at a total power capacity that is less than the sum of the maximum power requirements for each POE device. Thus, the total power required for a rack may be reduced by more efficient utilization.

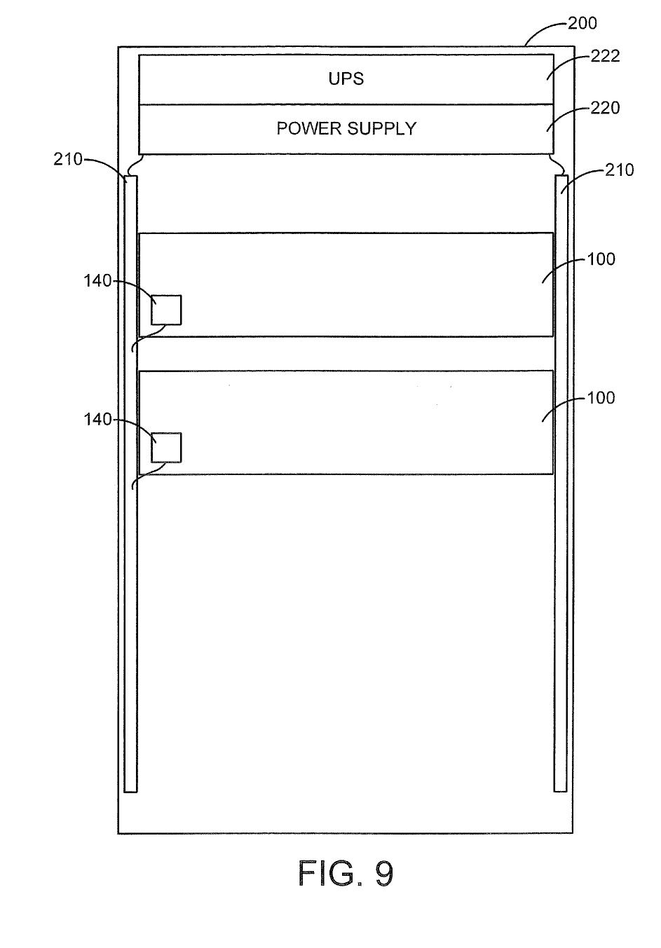

Reference is now made to FIG. 9, which is a rear cross-sectional view of a network patch panel rack including bus bars and an uninterruptible power supply according to some embodiments of the present invention. In addition to the components discussed above regarding FIG. 8, in some embodiments, the rack 200 includes an uninterruptible power supply (UPS) 222 configured to be coupled to the power supply 220. In some embodiments, the UPS 222 may be configured to provide standby power and/or shutdown instructions to components mounted within the rack 200 and to any remote network components that are receiving POE via the upgradeable patch panels 100. In some embodiments, the UPS is a modular UPS such that modules may be combined to support a variety of power level and standby period durations.

In some embodiments, the UPS 222 may be coupled to individual upgradeable network patch panels 100 mounted within the rack 200 and thus to any remote network components that are receiving POE via the upgradeable patch panels 100. In this manner, power requirements for the UPS 222 may be less than the maximum power required for the rack 200.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. (canceled)

2. A communications patch panel, comprising:
a plurality of jacks that are configured to receive a plurality of communications cables; and
a power interface that is configured to connect to a power device and selectively provide power to a remote communication device via one of the plurality of jacks and a corresponding one of the plurality of communications cables,
wherein the power device is installed responsive to connection of the remote communication device.

3. The communications patch panel of claim 2, wherein the power device comprises a power distributor that is configured to provide power to the remote communication device via the power interface and wherein the power interface comprises a power distributor interface that is configured to provide power to a subset of the plurality of jacks and that is further configured to receive the power distributor.

4. The communications patch panel of claim 3,
wherein the power distributor interface comprises a socket,
that includes a plurality of socket electrical contacts,
wherein the power distributor comprises a plurality of distributor electrical contacts, and
wherein the socket electrical contacts are configured to conductively engage the distributor electrical contacts.

5. (canceled)

6. The communications patch panel of claim 4, wherein the socket is internal to the panel and is configured to receive the power distributor via an opening that provides access into an interior of the panel.

7. (canceled)

8. The communications patch panel of claim 2, wherein the power interface comprises a plurality of electrical contacts that are configured to engage a plurality of electrical contacts on the power device.

9-10. (canceled)

11. The communications patch panel of claim 2, a bus bar interface that is configured to receive power from a plurality of bus bars mounted in a rack that is configured to receive the panel, wherein the bus bar interface provides power to the power interface.

12. A rack configured to receive the panel of claim 2, comprising:
a chassis that is configured to support the panel;
a plurality of bus bars that are configured to distribute power to the panel; and
a power supply interface that is configured to receive at least one power supply.

13. (canceled)

14. An upgradeable panel system, comprising:
a power distributor that is configured to provide power to a remote communication device via a network connection;
a communication panel comprising:
a jack that is configured to receive a plug of a communication cable that is connected to the remote communication device;
a power distributor interface that is coupled to the jack, the power distributor interface configured to connect to the power distributor and to transmit power to the remote communication device via the jack and the communication cable;
a power input interface that is configured to receive electrical power for transmission to the power distributor; and
a chassis configured to retain the jack, the power distributor interface and the power input interface; and
an input power device that is configured to be connected to the power input interface and that is configured to provide electrical power to the power distributor.

15. The system of claim 14, wherein the communication panel comprises a plurality of jacks and wherein the power distributor comprises a selective power distributor that is configured to transmit power to only a subset of the plurality of jacks.

16. The system of claim 14, wherein the communication panel comprises:
a plurality of jacks located proximate to a front plate; and
an opening in the front plate that is configured to receive the power distributor corresponding to a subset of the plurality of jacks, wherein at least one of the subset of the plurality of jacks is configured to transmit power to at least one remote communication device via at least one of a plurality of communication cables that is connected to the at least one of the subset of the plurality of jacks.

17. (canceled)

18. The system of claim 14, further comprising a plurality of bus bars that are configured to transmit power from the input power device to the power input interface.

19. (canceled)

20. The system of claim 14, wherein the panel further comprises an uninterruptible power supply interface that is configured to be coupled to an uninterruptible power supply.

21. A communications patch panel, comprising:
a plurality of jacks that are configured to receive a plurality of communications cables;
a first power interface that is coupled to a first subset of the plurality of jacks;
a first selective power distributor that is configured to be received by the first power interface and to provide power to at least one of the first subset of the plurality of jacks via the first power interface; and
a second power interface that is configured to be coupled to a power supply, wherein the second power interface is coupled to the first power interface and is configured to couple power from the power supply to the first power interface.

22. The communications patch panel of claim 21, wherein a faceplate of the patch panel includes an opening that is configured to receive the first selective power distributor.

23. The communications patch panel of claim 22, wherein the first selective power distributor includes a first set of contacts and the first power interface includes a second set of contacts that are configured to mate with the first set of contacts on the first selective power distributor.

24. The communications patch panel of claim 21, further comprising:
a third power interface that is coupled to a second subset of the plurality of jacks;
a second selective power distributor that is configured to be received by the third power interface and to provide power to at least one of the second subset of the plurality of jacks via the third power interface;
wherein the second power interface is further coupled to the third power interface and is configured to couple power from the power supply to the third power interface.

25. The communications patch panel of claim 2, wherein the power device comprises a first power device, the patch panel further comprising:
a second power device that is coupled to all of the plurality of jacks;
an internal power interface that is configured to receive the second power device; and
a bus bar interface that is configured to receive power from a rack-mounted bus bar and provide power to the first power device and/or the second power device.

26. A communications patching system that is upgradeable to provide power-over-Ethernet capability, comprising:
a communications patch panel that includes a plurality of jacks and a power interface that is coupled to at least some of the plurality of jacks; and
a power distributor that is configured to be inserted into an opening in the patch panel,
wherein the power interface is configured to receive the power distributor, and
wherein the patch panel is configured to provide power to at least some of the plurality of jacks to provide power-over-Ethernet capability to at least some of the plurality of jacks when the power distributor is received within the power interface.

27. The communications patch panel of claim 26, wherein the power interface comprises a socket having a plurality of electrical contacts and wherein the power distributor includes a plurality of electrical contacts that mate with the electrical contacts of the power interface.

28. The communications patch panel of claim 27, wherein the power distributor is configured to only provide power-over-Ethernet capability to a subset of the plurality of jacks.
